(19) United States
(12) Patent Application Publication
(10) Pub. No.: US 2018/0343342 A1
(43) Pub. Date: Nov. 29, 2018

(54) CONTROLLED ENVIRONMENT COMMUNICATION SYSTEM FOR DETECTING UNAUTHORIZED EMPLOYEE COMMUNICATIONS

(71) Applicant: Global Tel*Link Corporation, Reston, VA (US)

(72) Inventor: Todd DENNISON, Ponte Vedra, FL (US)

(73) Assignee: Global Tel*Link Corporation, Reston, VA (US)

(21) Appl. No.: 15/603,071

(22) Filed: May 23, 2017

(51) Int. Cl. H04M 3/22; H04M 3/20; H04M 3/38; H04M 3/42; H04N 7/14; G06K 9/00; G10L 17/00

(52) U.S. Cl. CPC H04M 3/2281; H04M 3/20; H04M 3/38; H04M 3/42221; G06Q 10/105; G06K 9/00288; G10L 17/005; H04M 2203/6054; H04M 2203/558; H04N 7/147

(57) ABSTRACT

A system is disclosed for detecting communications involving an employee of a controlled environment facility. The system maintains an employee database in which are stored employee data records containing various biometric entries corresponding to the employees of the facility. During a communication that utilizes the facility communication system, standard checks are performed on biometric data of call participants against third party detections and prohibited participant detections. Additionally, the system queries the employee database to determine whether the biometric sample obtained from the communication corresponds to biometric data associated with any of the employee data records. A match is determined as evidence prohibited resident-employee fraternization, and triggers remedial action by the system.

### BACKGROUND

### Field

This disclosure relates to a communication system capable of detecting unauthorized employee communications that are either made from within a controlled environment facility, or that involve an inmate of the controlled environment facility.

### Background

Controlled environment facilities, such as prisons, place numerous restrictions on communications afforded to residents of such facilities. These restrictions come in many forms, such as a limit on an amount of phone calls permitted, restricting whom the resident is permitted to contact, monitoring calls for certain keywords and phrases to prevent planning of illegal activities, etc. Although most of these security measures target the resident specifically, some restrictions and monitoring efforts also examine the activities of the called party.

### BRIEF DESCRIPTION OF THE DRAWINGS/FIGURES

The accompanying drawings, which are incorporated herein and form a part of the specification, illustrate embodiments of the present disclosure and, together with the description, further serve to explain the principles of the disclosure and to enable a person skilled in the pertinent art to make and use the embodiments.

FIG. 1 illustrates a block diagram of an exemplary facility-based communication environment according to embodiments of the present disclosure.

FIG. 2 illustrates a block diagram of an exemplary communication system that may be implemented in the communication environment of FIG. 1, according to embodiments of the present disclosure.

FIG. 3 illustrates an exemplary call monitoring system for use in the exemplary communication system of FIG. 2, according to embodiments of the present disclosure.

FIG. 4 illustrates a block diagram of an exemplary centralized communication environment, according to embodiments of the present disclosure.

FIG. 5 illustrates a flowchart diagram of an exemplary method for registering residents and employees of the controlled environment facility, according to embodiments of the present disclosure.

FIG. 6 illustrates a flowchart diagram of an exemplary method for monitoring a call processed by the exemplary communication systems of FIG. 2 or FIG. 4, according to embodiments of the present disclosure.

FIG. 7 illustrates a block diagram of a general purpose computer that may be used to perform various aspects of the present disclosure.

The present disclosure will be described with reference to the accompanying drawings. In the drawings, like reference numbers indicate identical or functionally similar elements. Additionally, the left most digit(s) of a reference number identifies the drawing in which the reference number first appears.

### DETAILED DESCRIPTION

The following Detailed Description refers to accompanying drawings to illustrate exemplary embodiments consistent with the disclosure. References in the Detailed Description to “one exemplary embodiment,” “an exemplary embodiment,” “an example exemplary embodiment,” etc., indicate that the exemplary embodiment described may include a particular feature, structure, or characteristic, but every exemplary embodiment may not necessarily include the particular feature, structure, or characteristic. Moreover, such phrases are not necessarily referring to the same exemplary embodiment. Further, when a particular feature, structure, or characteristic is described in connection with an exemplary embodiment, it is within the knowledge of those skilled in the relevant art(s) to affect such feature, structure, or characteristic in connection with other exemplary embodiments whether or not explicitly described.

The exemplary embodiments described herein are provided for illustrative purposes, and are not limiting. Other exemplary embodiments are possible, and modifications may be made to the exemplary embodiments within the spirit and scope of the disclosure. Therefore, the Detailed Description is not meant to limit the disclosure. Rather, the scope of the disclosure is defined only in accordance with the following claims and their equivalents.

Embodiments may be implemented in hardware (e.g., circuits), firmware, software, or any combination thereof. Embodiments may also be implemented as instructions stored on a machine-readable medium, which may be read and executed by one or more processors. A machine-readable medium may include any mechanism for storing or transmitting information in a form readable by a machine (e.g., a computing device). For example, a machine-readable medium may include read only memory (ROM); random access memory (RAM); magnetic disk storage media; optical storage media; flash memory devices; electrical, optical, acoustical or other forms of propagated signals (e.g., carrier waves, infrared signals, digital signals, etc.), and others. Further, firmware, software, routines, instructions may be described herein as performing certain actions. However, it should be appreciated that such descriptions are merely for convenience and that such actions in fact result from computing devices, processors, controllers, or other devices executing the firmware, software, routines, instructions, etc. Further, any of the implementation variations may be carried out by a general purpose computer, as described below.

For purposes of this discussion, any reference to the term “module” shall be understood to include at least one of software, firmware, and hardware (such as one or more circuit, microchip, or device, or any combination thereof), and any combination thereof. In addition, it will be understood that each module may include one, or more than one, component within an actual device, and each component that forms a part of the described module may function either cooperatively or independently of any other component forming a part of the module. Conversely, multiple modules described herein may represent a single component within an actual device. Further, components within a module may be in a single device or distributed among multiple devices in a wired or wireless manner.

The following Detailed Description of the exemplary embodiments will so fully reveal the general nature of the disclosure that others can, by applying knowledge of those skilled in relevant art(s), readily modify and/or customize for various applications such exemplary embodiments, without undue experimentation, without departing from the spirit and scope of the disclosure. Therefore, such modifications are intended to be within the meaning and plurality of equivalents of the exemplary embodiments based upon the teaching and guidance presented herein. It is to be understood that the phraseology or terminology herein is for the purpose of description and not of limitation, such that the terminology or phraseology of the present specification is to be interpreted by those skilled in relevant art(s) in light of the teachings herein.

This disclosure pertains to security measures taken with respect to communications involving parties residing within, or communicating within a controlled environment facility. Such controlled-environment facilities may include prisons, hospitals, jails, nursing homes, schools, office buildings, government agencies, etc., or any other facility or environment where communications may wish to be controlled, restricted, or monitored. This disclosure will be described in the context of a prison facility.

In such controlled-environment facilities, there is typically a desire to restrict access to a communication system, control the amount, types, and manners of outgoing and incoming communications, and often monitor such communications. There are many reasons why such restrictions are desired, but primarily are implemented for security and financial concerns. Namely, in controlled environments, residents often have access to a variety of different communication devices. Without being able to positively identify the caller, revenues often are lost due to an inability to collect. Additionally, particularly in prisons and other types of correctional facilities, access must be carefully controlled to prevent communications with prohibited parties, such as judges, jury members, victims, other gang members, etc. Nonetheless, particularly for increasing recidivism, there is a strong desire to permit frequent communications with family members and other good and positively influential friends.

One type of individual that is often overlooked in the context of controlled environment facilities are employees. Most employees of such facilities undergo an initial security screening process that includes a background check. A successful screen gives the employer peace of mind to entrust the employee to carry out his/her responsibilities in good faith. However, occasionally, a controlled environment employee will begin fraternizing with inmates, which is usually permitted out of a concern for corruption. Even more occasionally, such an employee will become corrupted and begin performing bad or illegal acts, some of which can be captured in communications processed by the communication system for the facility. Because of their “authorized” status, the employee's actions often go undetected. This can create a significant danger for the other employees, and even the residents, of the controlled environment facility, and should nonetheless be prevented for purposes of thwarting those bad/illegal actions. Therefore, a system is disclosed herein to not only carry out typical call authentication and monitoring, but to also perform an additional security scan of communications to detect the presence of an employee. This, and other aspects, are described in detail below.

### Exemplary Communication Environment

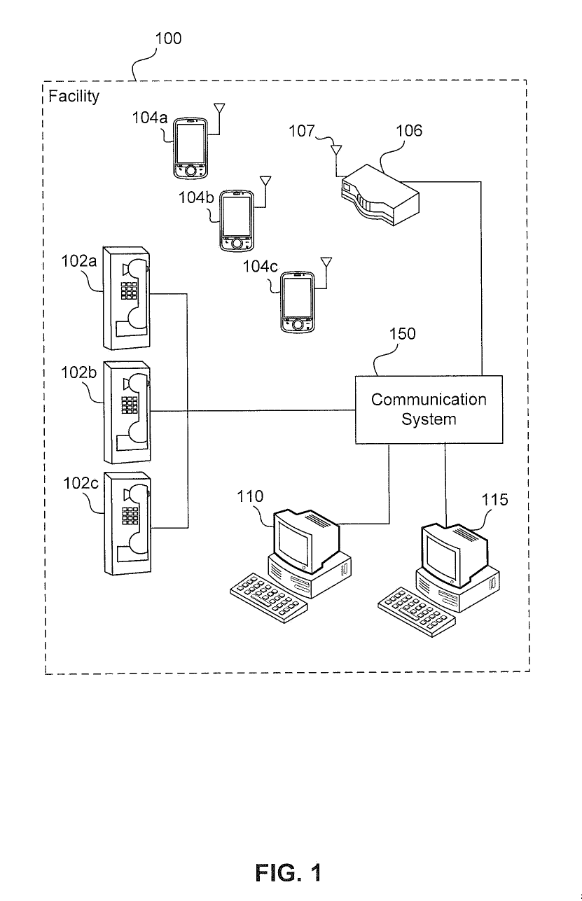

FIG. 1 illustrates a block diagram of an exemplary facility-based communication environment 100, according to embodiments of the present disclosure. The environment includes a plurality of and a variety of communication devices for allowing inmates to communicate with outside parties. Such communication devices include standard hardwired telephones 102a-102c, wireless communication device 104a-104c, and one or more computer terminals 110. In an embodiment, the hardwired telephones 102 are VoIP-based telephones that communicate over a digital IP (packet-switched) network. However, in other embodiments, the hardwired telephones 102 are POTS (Plain Old Telephone System) phones that operate on a circuit-switched network.

In an embodiment the wireless communication devices 104 are facility-issued Personal Inmate Devices (PIDs). The PIDs are in the form of a tablet computing device or a cellular telephone device and are secured from communications with outside cellular towers. The PIDs include significant security and authentication measures to ensure proper usage by proper inmates. An example embodiment of a wireless communication device 104 is described in U.S. application Ser. No. 13/946,637 (now U.S. Pat. No. 9,307,386) filed on Apr. 5, 2016, entitled Multifunction Wireless Device, which is hereby incorporated by reference in its entirety.

One or more computer terminals 110 are also included within the environment 100. In an embodiment, the computer terminal 110 is a video conferencing terminal capable of facilitating a video communication (such as a video conference, or a video call). Such computer terminal 110 is subject to the same or similar authentication requirements as other communication devices within the environment 100. In an embodiment, the computer terminal 110 may also implement additional security measures due to the nature of video communications, such as facial framing (e.g., requiring a face to remain in a frame of the camera), detection prohibited motions and gestures, etc. An exemplary embodiment of such a computer terminal 110 is described in U.S. application Ser. No. 15/002,073 filed on Jan. 20, 2016, entitled Secure Video Visitation System, which is hereby incorporated by reference in its entirety.

The facility-based environment 100 also includes a communication system 150 located on-site at the facility for carrying out all manner of communication processing. In an embodiment, devices, such as hardwired telephones 102 and computer terminal 100, are wire-connected to the communication system 150, whereas wireless communication devices 104 are wirelessly connected to the communication system 150. In order to facilitate the wireless connections to the communication system 150, a router (or other wireless access point) 106 is connected to the communication system 150. The router 106 includes antenna 107 to receive electromagnetic radiation of transmissions from the wireless communication devices 104. These signals are decoded and/or demodulated by the router 106 into a form that is compatible with the communication system. Although not shown, a switch or other routing device can perform similar functionality for coalescing the signals generated by the hardwired devices (e.g., hardwired telephones 102 and computer terminal 110).

Also connected to the communication system 150 is an administrative terminal 115. The administrative terminal 115 is accessible only by authorized personnel of the controlled environment facility. The administrative terminal 115 allows personnel to perform administrative tasks, such as review call logs, register new inmates, monitor recorded or live communications, edit database entries, etc. This information flows into the communication system 150, which functions both as the communication processing server and central data hub for the facility. In alternative embodiments, data storage is not maintained directly within the communication system 150, but rather separate from the communication system, either nearby or at a remote facility.

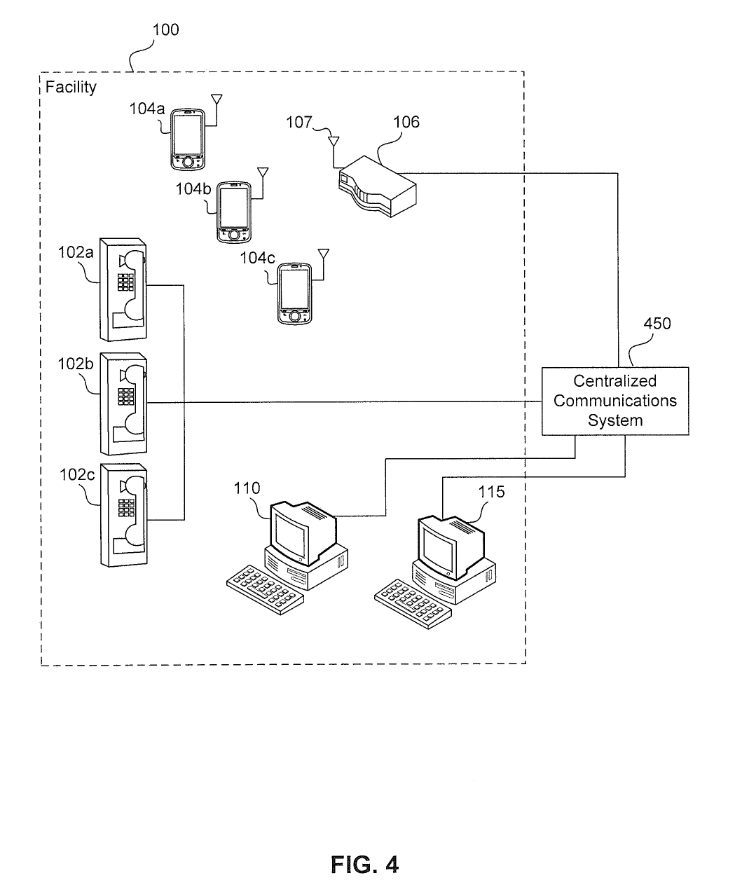

FIG. 4 illustrates an alternative embodiment of that of FIG. 1, and illustrates a block diagram of an exemplary centralized controlled facility communication environment 400. In the embodiment of FIG. 4, like configurations are illustrated with the same reference numerals as those of FIG. 1. In the centralized configuration, the facility 100 does not includes the communication system 150. Rather, communications from the various devices of the facility 100 are routed to a centralized communications system 450. The centralized communication system 450 is structured substantially the same as the communication system 150, except that the centralized communication system 450 may serve multiple different facilities, and sometimes numerous facilities. Therefore, the centralized communication system 450 is typically far more robust then a facility-based system, such as communication system 150.

Additionally, in an embodiment, the centralized communication system 450 leaves certain functional responsibilities with the individual facilities. For example, since the centralized communication system 450 is located centrally to multiple facilities, the system 450 is in the network, and possibly within the public network. Access to the public network is typically carefully guarded. As a result, caller authentication may be retained at the facility in order to restrict network access only to properly authenticated individuals. Other functionality described with respect to the communication system, below, may also optionally be retained at the facility 100.

### Exemplary Communication System

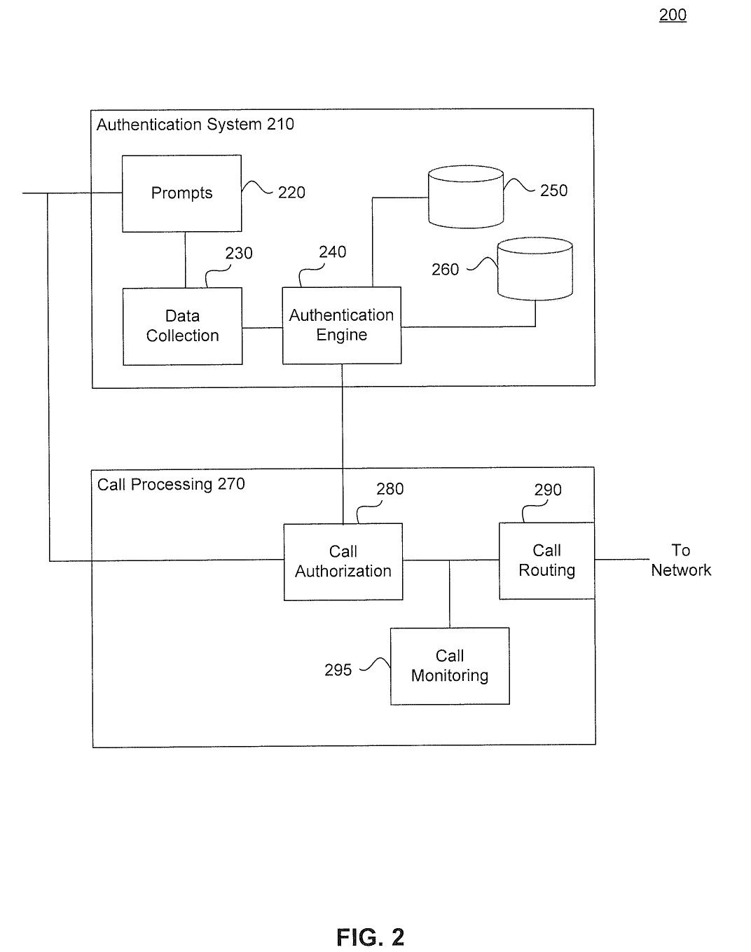

FIG. 2 illustrates a block diagram of an exemplary communication system 200, according to embodiments of the present disclosure. The communication system 200 includes an authentication system 210 and a call processing system 270, and may represent an exemplary embodiment of the communication system 150 and/or communication system 450.

The authentication system 210 includes data collection 230 and an authentication engine 240, and is responsible for acquiring, processing, and authenticating identification information of at least a calling party. As illustrated, the authentication system 210 also includes an inmate database 250 and an employee database 260. However, it should be understood that the databases 250 and 260 can be located elsewhere and be accessible by the authentication system 210. The databases 250/260 are repeatedly updated with new identification information upon new admittances/hirings.

For example, the inmate database includes all manner of information relating to inmates of the controlled environment facility 100. Such information may include inmate name, call restrictions, number white/black list, personal identification number, biometric reference data, financial information, etc. The inmate database 250 is updated each time a new inmate is admitted to the facility. Upon admittance, a registration process occurs, in which authorized personnel use the administrative tel 115 to generate an inmate data record for the inmate that includes the above-described information. Some of this information is manually entered, whereas others is received from an input device. In an embodiment, at least the biometric reference data is received from an input device, such as a biometric sensor. In an embodiment, the biometric sensor may include a microphone, camera, pressure pad, infrared detector, etc. for purposes of capturing voice data, facial information, fingerprint data, heat signatures, respectively. Other biometric data is envisioned that can be captured using other types of biometric sensing devices. After all necessary information has been captured, the information is organized and stored in the database as part of the registering inmate's data record.

In an embodiment, the inmate database 250 and the employee database 260 store former individuals as well as current individuals. For example, the inmate database 250 also stores inmate data records for former inmates (e.g., inmates that previously resided within the controlled-environment facility, but have since been released, etc.) that were registered in the database. Likewise, the employee database 260 stores employee data records for former employees (e.g., employees that were previously employed with the facility, jurisdiction, etc., but which are no longer employed). In embodiments, the employee database 260 can also include applicants for employment, but were never actually employed.

A similar process to that described above with respect to inmates is also carried out for new employees. However, for each new employee, employee data records are stored in the employee database 260.

With the databases 250 and 260 populated with inmate and employee data records, respectively, call participant authentication and monitoring can be adequately performed. For example, when an inmate seeks to establish a communication, whether by telephone, video or otherwise (hereinafter “a call”), that inmate is first authenticated by the authentication system 210. The outgoing call is received by the authentication system 210. The system prompts 220 the caller to perform certain tasks to satisfy the authentication process. In an embodiment, the prompts are carried out by an interactive voice response (IVR) system that issues voice commands. In response to the prompts, the inmate first enter certain identification information, such as a PIN or other identifier to identify himself. Data provided by the inmate is received and processed by data collection 230. The data collection 230 coordinates with the prompts 220 to identify the type of information received. Based on the received information and the identified type, the authentication engine 240 carries out the authentication process.

For example, in response to the inmate entering the identification information, the authentication retrieves the corresponding inmate data record from the inmate database 250. After receipt of the identification information, and retrieval of the relevant inmate data record, the inmate is prompted to enter secondary identification information, usually in the form of biometric data. The data collection 230 receives the entered data, and identifies its type (as fingerprint, voice, facial data, etc.). The authentication engine 240 then retrieves the biometric data of a like type form the retrieved inmate data record to perform statistical matching. In some cases, the biometric data received from the inmate can be processed in raw form. However, other types, such as voice data for example, requires certain front-end processing (such as Fourier transforming, filtering, etc.). The authentication engine 240 performs any necessary front-end processing, and then performs the statistical matching to the retrieved biometric data from the inmate data record.

If the statistical matching process shows a correlation between the two biometric samples that exceeds some predetermined threshold, then the inmate is authenticated and is permitted to access the network for purposes of attempting to establish the desired communication. However, if the statistical matching process shows a correlation that falls below the predetermined threshold, then the authentication fails and the inmate is prohibited from accessing the network. In embodiments, a predetermined number of failed attempts may be permitted before permanently terminating the access attempt. The authentication system 210 forwards an “AUTHENTICATION SUCCESS” or “AUTHENTICATION FAIL” notification to the call processing 270 based on the authentication result.

In an embodiment, the same method as described above can be carried out for employee communications, except that the authentication engine retrieves a relevant employee data record from the employee database based on the provided identification information.

The call processing system 270 receives the notification from the authentication system 210 as to whether authentication succeeded or failed. Upon failure, the call authorization 280 of the call processing 270 terminates the call and issues an alert to relevant personnel. On the other hand, upon successful authentication, the call authorization 280 provides network access to the caller via call routing 290. The call routing 290 forwards the call to a desired destination or next node of the network.

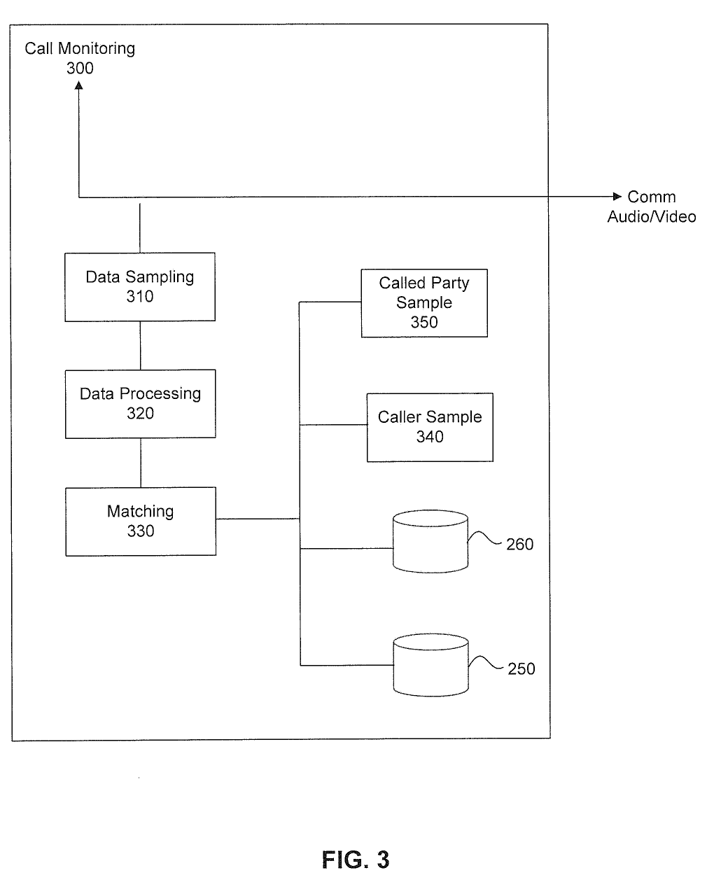

As the call proceeds, the call processing 270 continues to monitor the call for inappropriate participants, language, etc. Call monitoring 295 links into the communication channel of the call in order to monitor the language and activities of the ongoing communication. The functionality of the call monitoring 295 is further described with respect to FIG. 3.

Although the system has been described above with respect to real-time “live” communications, the disclosure is not limited to such an embodiment. In another embodiment, the system can function on previously-recorded calls. For example, the identification information submitted during the call for authentication purposes can be stored along with the audio data of the call. Then, at a later time, the data is compared against the data records stored in the inmate database 250 and employee database 260.

In embodiments, the system described above can also function on in-person communications, such as visitations. When a visitation is conducted across safety glass, as is common, telephone lines connect the parties on the opposite sides of the glass so that they can converse. In this embodiment, those telephone lines can output the audio data to the call processing system 270 for comparison to the data records in the inmate database 250 and employee database 260. When an in-person communication does not use telephone lines, hidden microphones can capture the audio of the in-person conversation.

### Exemplary Call Monitoring System

FIG. 3 illustrates an exemplary embodiment of call monitoring system 300 for use in the exemplary communication system of FIG. 2, according to embodiments of the present disclosure. The call monitoring system 300 includes data sampling 310, data processing 320, and matching 330, and may represent an exemplary embodiment of call monitoring 295 of FIG. 2.

In the call monitoring system 300, data sampling 310 is tapped into the audio and/or video of an ongoing communication. The data sampling 310 acquires data samples of different participants at different times throughout the communication. In an embodiment, data samples are captured at regular intervals. In other embodiments, performs speaker identification for purposes of sampling different speakers. In this process, the data sampling maintains an ongoing recording window of the communication for process, and detects transitions in communication from one speaker to another through analysis and audio cues. Sampling is performed for audio/video portions corresponding to those transitions in order to capture different speakers at different times of the communication.

The data sampling forwards data samples to data processing 320. Data processing performs any necessary front end signal processing on the received data samples. As discussed above, such processing may include any data processing beneficial for, or necessary for, obtaining a usable data sample, such as filtering, frequency transforming, etc. Data processing 320 forwards the processed data samples to the matching 330. The matching undertakes a stepwise matching process for determining an identity of a participant associated with the sample.

As shown in FIG. 3, the matching 330 has access to the caller sample 340, as well as the inmate database 250 and the employee database 260. Under normal circumstances, there is approximately a 50% chance of a given data sample belonging to the caller. Thus, the matching 330 first compares the data sample to the biometric sample of the same type associated with the calling inmate's data record 340. Matching is performed in substantially the same manner as described above with respect to the authentication engine 240. In response to a successful match, matching 330 does not take any further action with regard to a call. However, in response to an unsuccessful match, matching 330 then performs a caller comparison.

If no caller data has yet been stored, then the matching performs matching of the data sample against all other inmate biometric data and employee biometric data to determine if the caller is communicating with another inmate or an employee of the facility. In an embodiment, matching may be performed against a subset of the inmate data records and/or employee data records. If a match is detected from either of these matching processes, then the matching issues an alert to relevant personnel and terminates the call. In an embodiment, the matching sends the alert, but does not terminate the call, instead triggering call recording (if not already underway) for investigative purposes. If, on the other hand, no match is found among the inmate and employee databases, then the data sample is stored as that of the called party 350.

Later in the call, when the matching 330 determines that a given sample is not that of the calling inmate's, then a comparison is made to the stored called party sample 350. A match to the called party sample causes the matching 330 to take no immediate action with respect to the call. However, if the data sample does not match the called party sample, 350, then matching determines that a third party has joined the call. As a result, the matching checks the data sample against the inmate database 250 and employee database 260 in the manner previously described, and then issues an alert to relevant personnel along with the identified third party (if matched to an inmate or employee). As a result of these processes, the call monitoring 300 is able to detect communications involving an employee of the facility.

Although the above has been described with respect to an employee of the facility 100, the functionality of the matching 330 can also be expanded to check against employees of other facilities. However, reactionary measures taken by the matching 330 in response to such a match should be tempered relative to a match of an employee of the immediate facility 100, as such a communication may not be prohibited or involve nefarious behavior. Therefore, in an embodiment, the call is permitted to proceed, but flagged for later review. In another embodiment, following review by authorized personnel, the detected employee call participant may be added to a list of authorized participants, such that future detections will not cause a response from matching 330.

### Exemplary Registration and Authentication Method

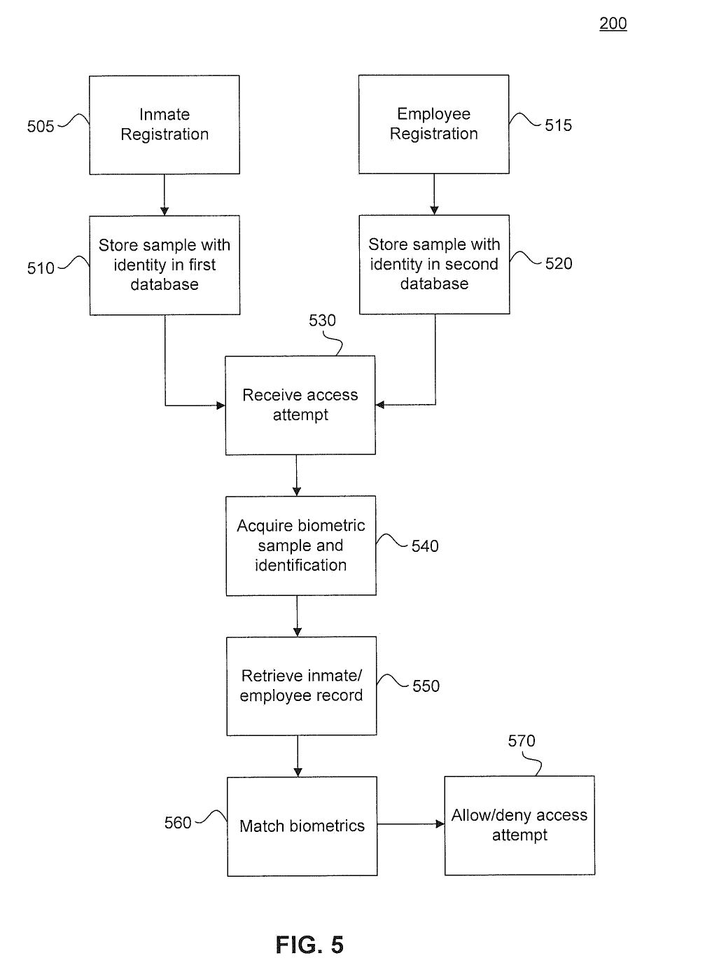

FIG. 5 illustrates a flowchart diagram of an exemplary method 500 for registering residents and employees of the controlled environment facility 100, according to embodiments of the present disclosure. The method of FIG. 5 is described in detail below with reference to the preceding figures and reference numerals.

As shown in FIG. 5, inmate registration 505 and employee registration 515 can occur independently and simultaneously. In the inmate registration 505, authorized personnel access the communication system 150 in order to establish an inmate data record for the inmate. This is performed by manually entering certain data and acquiring certain other data relating to the inmate. The employee registration 515 is carried out in similar fashion.

As part of the registration 505/515, a biometric sample of the inmate is stored 510 with identifying information of the inmate, such as a PIN, in the form of an inmate data record. Likewise, following employee registration 515, a biometric sample is stored 520 in association with identification information of the employee in the form of an employee data record.

After registration, the communication system 150/450 receives an access attempt 530 from a caller. The caller submits identification information and biometric data 540 to the communication system 150/450. Using the identification information, the system retrieves a data record from a corresponding database 550. Utilizing the biometric data previously stored in the retrieved data record, a matching process is carried out to determine whether the submitted biometric data sample matches the retrieved biometric sample of the same type 560. The access attempt is then allowed or denied 570 based on the results of the matching process.

### Exemplary Call Monitoring and Employee Detection Method

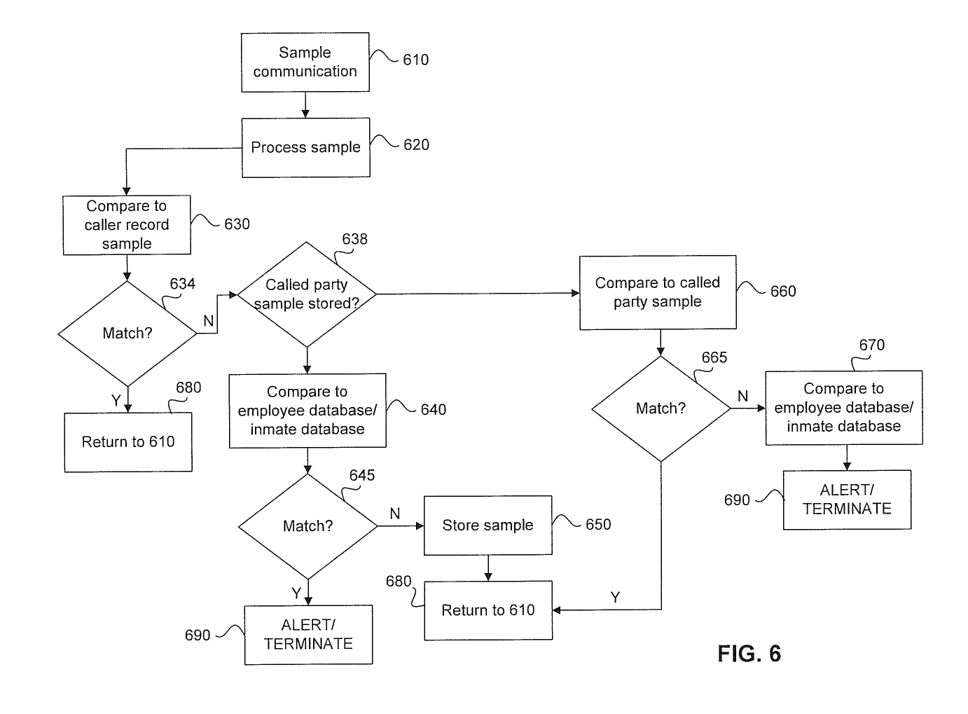

FIG. 6 illustrates a flowchart diagram of an exemplary method 600 for monitoring a call processed by the exemplary communication systems 200/450 of FIG. 2 or FIG. 4, according to embodiments of the present disclosure.

During an ongoing communication, the communication is sampled 610. The sample may be in the form of audio data, facial data, or other data capable of being used to identify a call participant. The sample may be acquired at periodic intervals, or based on other criteria, such as detected speaker transitions, etc. Signal processing 620 is then performed on the acquired data sample in order to place the sample in a form usable for analysis. Such processing may include filtering, frequency transforming, etc.

Once the sample is in a good useable condition, the sample is statistically compared 630 to a biometric sample of the same type associated with the data record of the caller. A determination is then made, based on the comparison, as to whether the samples are a statistical match 634. If a match is detected (634-Y), the sample is identified as belonging to the previously-authenticated caller, and the method begins again 680.

If a match is not is not detected (634-N), then a determination is made as to whether a called party biometric sample has previously been stored 638. If no previously-stored called party biometric sample exists (638-N), then the sample is compared 640 against biometric samples of the same type of each of the inmate data records and employee data records. A determination is then made as to whether the sample is a statistical match to any of those data record biometric samples 645. If a match is detected (645-Y), then remedial action is taken 690, such as by the issuing of an alert and the terminating of the call. On the other hand, if no match is detected (645-N), then the sample is stored 650 as the called party biometric sample. The method then begins again 680.

Meanwhile, if the sample is determined not to belong to the caller (634-N), and there is already a previously-stored called party biometric sample (638-Y), then the sample is compared to the previously stored called party biometric sample 660. A determination is then made as to whether the sample matches the previously stored called party biometric sample 665. If a match is detected (665-Y), then the method begins again 680. If on the other hand, no match is detected (665-N), then the sample is compared 670 against the biometric data stored in the data records of the inmate database 250 and employee database 260. The call is then terminated and an alert is generated 690 to notify relevant personnel of a detected unauthorized third party on the call, and an identity of the unauthorized third party if a match was detected in either the inmate database 250 or the employee database 260.

The method continues in the manner described above until the call is terminated, whether by the communication system, the caller, the called party, or via other means.

### Other Embodiments

Although the systems described above were with respect to real-time “live” communications, the disclosure is not limited to such an embodiment. In another embodiment, the system can function on previously-recorded calls. For example, the identification information submitted during the call for authentication purposes can be stored along with the audio data of the call. Then, at a later time, the identification data and/or the audio data can be analyzed to extract the biometric data samples. Those biometric data samples can then be compared against the data records stored in the inmate database 250 and employee database 260, in the same manner as described above, but after the communication has occurred.

In embodiments, the system described above can also function on in-person communications, such as visitations. When a visitation is conducted across safety glass, as is common, telephone lines connect the parties on the opposite sides of the glass so that they can converse. In this embodiment, those telephone lines can output the audio data to the call processing system 270 for comparison to the data records in the inmate database 250 and employee database 260. When an in-person communication does not use telephone lines, hidden microphones can capture the audio of the in-person conversation

### Exemplary Computer Implementation

It will be apparent to persons skilled in the relevant art(s) that various elements and features of the present disclosure, as described herein, can be implemented in hardware using analog and/or digital circuits, in software, through the execution of computer instructions by one or more general purpose or special-purpose processors, or as a combination of hardware and software.

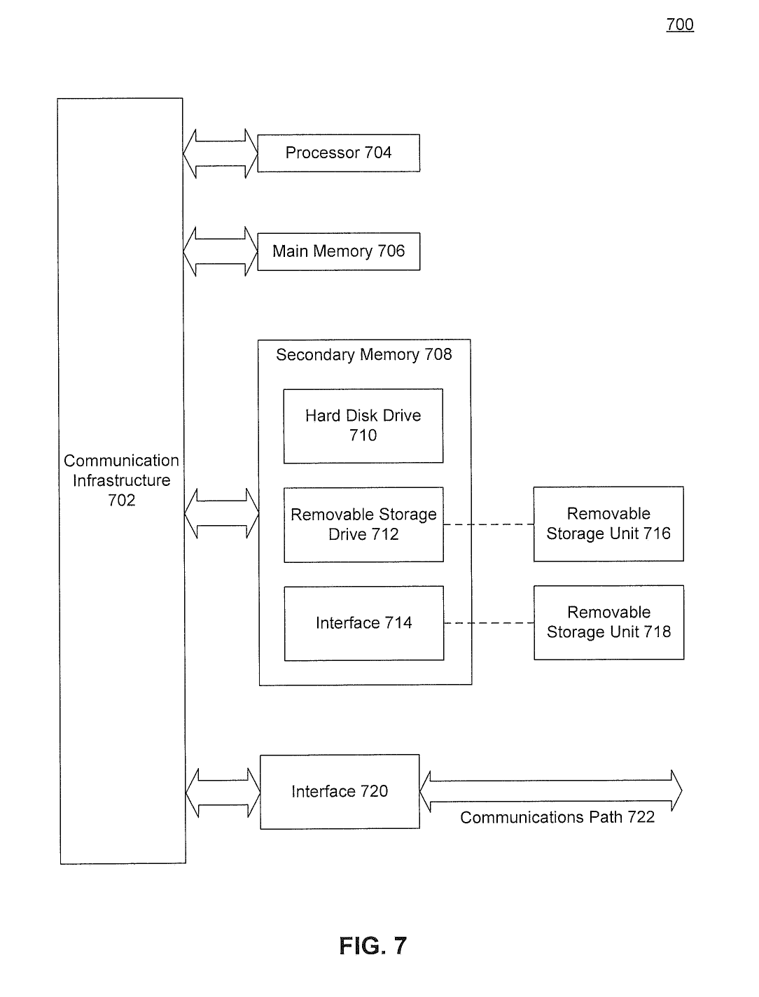

The following description of a general purpose computer system is provided for the sake of completeness. Embodiments of the present disclosure can be implemented in hardware, or as a combination of software and hardware. Consequently, embodiments of the disclosure may be implemented in the environment of a computer system or other processing system. For example, the methods of FIGS. 5 and 6 can be implemented in the environment of one or more computer systems or other processing systems. An example of such a computer system 700 is shown in FIG. 7. One or more of the modules depicted in the previous figures can be at least partially implemented on one or more distinct computer systems 700.

Computer system 700 includes one or more processors, such as processor 704. Processor 704 can be a special purpose or a general purpose digital signal processor. Processor 704 is connected to a communication infrastructure 702 (for example, a bus or network). Various software implementations are described in terms of this exemplary computer system. After reading this description, it will become apparent to a person skilled in the relevant art(s) how to implement the disclosure using other computer systems and/or computer architectures.

Computer system 700 also includes a main memory 706, preferably random access memory (RAM), and may also include a secondary memory 708. Secondary memory 708 may include, for example, a hard disk drive 710 and/or a removable storage drive 712, representing a floppy disk drive, a magnetic tape drive, an optical disk drive, or the like. Removable storage drive 712 reads from and/or writes to a removable storage unit 716 in a well-known manner. Removable storage unit 716 represents a floppy disk, magnetic tape, optical disk, or the like, which is read by and written to by removable storage drive 712. As will be appreciated by persons skilled in the relevant art(s), removable storage unit 716 includes a computer usable storage medium having stored therein computer software and/or data.

In alternative implementations, secondary memory 708 may include other similar means for allowing computer programs or other instructions to be loaded into computer system 700. Such means may include, for example, a removable storage unit 718 and an interface 714. Examples of such means may include a program cartridge and cartridge interface (such as that found in video game devices), a removable memory chip (such as an EPROM, or PROM) and associated socket, a thumb drive and USB port, and other removable storage units 718 and interfaces 714 which allow software and data to be transferred from removable storage unit 718 to computer system 700.

Computer system 700 may also include a communications interface 720. Communications interface 720 allows software and data to be transferred between computer system 700 and external devices. Examples of communications interface 720 may include a modem, a network interface (such as an Ethernet card), a communications port, a PCMCIA slot and card, etc. Software and data transferred via communications interface 720 are in the form of signals which may be electronic, electromagnetic, optical, or other signals capable of being received by communications interface 720. These signals are provided to communications interface 720 via a communications path 722. Communications path 722 carries signals and may be implemented using wire or cable, fiber optics, a phone line, a cellular phone link, an RF link and other communications channels.

As used herein, the terms “computer program medium” and “computer readable medium” are used to generally refer to tangible storage media such as removable storage units 716 and 718 or a hard disk installed in hard disk drive 710. These computer program products are means for providing software to computer system 700.

Computer programs (also called computer control logic) are stored in main memory 806 and/or secondary memory 708. Computer programs may also be received via communications interface 720. Such computer programs, when executed, enable the computer system 700 to implement the present disclosure as discussed herein. In particular, the computer programs, when executed, enable processor 704 to implement the processes of the present disclosure, such as any of the methods described herein. Accordingly, such computer programs represent controllers of the computer system 700. Where the disclosure is implemented using software, the software may be stored in a computer program product and loaded into computer system 700 using removable storage drive 712, interface 714, or communications interface 720.

In another embodiment, features of the disclosure are implemented primarily in hardware using, for example, hardware components such as application-specific integrated circuits (ASICs) and gate arrays. Implementation of a hardware state machine so as to perform the functions described herein will also be apparent to persons skilled in the relevant art(s).

### CONCLUSION

It is to be appreciated that the Detailed Description section, and not the Abstract section, is intended to be used to interpret the claims. The Abstract section may set forth one or more, but not all exemplary embodiments, and thus, is not intended to limit the disclosure and the appended claims in any way.

The disclosure has been described above with the aid of functional building blocks illustrating the implementation of specified functions and relationships thereof. The boundaries of these functional building blocks have been arbitrarily defined herein for the convenience of the description. Alternate boundaries may be defined so long as the specified functions and relationships thereof are appropriately performed.

It will be apparent to those skilled in the relevant art(s) that various changes in form and detail can be made therein without departing from the spirit and scope of the disclosure. Thus, the disclosure should not be limited by any of the above-described exemplary embodiments, but should be defined only in accordance with the following claims and their equivalents.

What is claimed is:

1. A method for monitoring a communication involving a call participant located within a controlled-environment facility, the method comprising:
tapping into the communication;
extracting a biometric data sample from the communication;
first comparing the extracted biometric data sample to a previously-stored biometric data sample associated with the call participant;
second comparing the extracted biometric data sample to a previously-stored biometric data sample associated with an employee of the controlled-environment facility;
taking remedial action with respect to the communication based on a result of the second comparing.

2. The method of claim 1, wherein the call participant is an authenticated call participant.

3. The method of claim 1, further comprising determining, based on the first comparing, that the extracted biometric data sample is not a statistical match with the previously-stored biometric data sample associated with the call participant,
wherein the second comparing is performed in response to the determining.

4. The method of claim 1, further comprising determining that an authorized second party participant biometric sample has not been stored,
wherein the second comparing is performed in response to the determining.

5. The method of claim 4, further comprising:
second determining that the extracted biometric data sample is not a statistical match with the previously-stored biometric data sample associated with the employee of the controlled-environment facility; and
storing the extracted biometric sample as an authorized second party participant biometric sample.

6. The method of claim 1, further comprising:
determining that an authorized second party participant biometric sample has been stored; and
comparing the extracted data sample to the authorized second party participant biometric sample.

7. The method of claim 6, further comprising second determining that the extracted data sample is not a statistical match with the authorized second party participant biometric sample,
wherein the second comparing is performed in response to the second determining.

8. A communication system for providing communication services to a controlled-environment facility, the communication system comprising:
a communication device configured to facilitate a communication involving an inmate of the controlled-environment facility;
a communication processing system configured to process and monitoring the communication, the communication processing system including:
an authentication system configured to authenticate the inmate; and
a communication processor configured to monitor the communication, the monitoring including comparing a biometric data sample of the communication to a previously-stored biometric data sample associated with an employee of the controlled-environment facility.

9. The communication system of claim 8, further comprising:
an inmate database that stores an inmate data record of the inmate, the inmate data record including an identifier and a biometric sample associated with the inmate; and
an employee database that stores an employee data record of the employee, the employee data record including the biometric data sample associated with the employee.

10. The communication system of claim 9, wherein the authentication system is configured to authenticate the resident by:
receiving an identifier and a biometric sample from the inmate;
retrieving the inmate data record based on the received identifier; and
comparing the received biometric sample to the biometric sample associated with the inmate.

11. The communication system of claim 9, wherein the communication processor is configured to monitor the communication by:
extracting a biometric data sample from the communication;
comparing the extracted biometric data sample to the biometric data sample associated with the employee.

12. The communication system of claim 11, wherein the communication processor is further configured to monitor the communication by:
determining that the extracted biometric data sample is not a statistical match with the biometric data sample associated with the inmate,
wherein the comparing is performed in response to the determining.

13. The communication system of claim 11, wherein the communication processor is further configured to monitor the communication by:
determining whether an authorized outside party biometric data sample has been stored;
storing the extracted biometric data sample as the authorized outside party biometric data sample in response to determining that the authorized outside party biometric sample has not been stored; and
comparing the extracted biometric data sample to the authorized outside party biometric data sample in response to determining that the authorized outside party biometric sample has been stored.

14. The communication system of claim 13, wherein the communication processor is further configured to monitor the communication by:
determining that the extracted biometric data sample is not a statistical match with the authorized outside party biometric data sample,
wherein the comparing of the extracted biometric data sample to the biometric data sample associated with the employee is performed in response to the determining.

15. A method of monitoring a communication initiated by an inmate of a controlled-environment facility, and directed to an authorized called party, the method comprising:
extracting a biometric data sample from the communication;
comparing the extracted biometric data sample to a previously-stored biometric data sample associated with an employee of the controlled-environment facility;
taking remedial action with respect to the communication based on a result of the second comparing.

16. The method of claim 15, wherein the biometric data sample associated with the employee of the controlled-environment facility is stored as part of an employee data record in an employee database.

17. The method of claim 16, wherein employee database includes a plurality of employee data records corresponding to different employees of the controlled-environment facility, and
wherein the comparing includes comparing the extracted biometric data sample to previously-stored biometric data samples associated with each of the plurality of employee data records.

18. The method of claim 15, wherein the communication is a video call, and
wherein the biometric data sample is an image of a face.

19. The method of claim 15, further comprising:
determining a type of the extracted biometric data sample;
accessing a data record having multiple types of biometric data, and including the previously-stored biometric data sample; and
identifying the previously-stored biometric data sample as being of the same type as the extracted biometric data sample.

20. The method of claim 15, wherein the remedial action includes alerting a predetermined staff member and terminating the communication.
